(19) United States
(12) Patent Application Publication
(10) Pub. No.: US 2023/0255732 A1
(43) Pub. Date: Aug. 17, 2023

(54) DENTAL PROSTHESIS FABRICATION SYSTEM, DENTAL PROSTHESIS FABRICATION METHOD, DENTAL PROSTHESIS COLORING METHOD, DENTAL PROSTHESIS COLORING SYSTEM, AND PROGRAM

(71) Applicant: CANON KABUSHIKI KAISHA, Tokyo (JP)

(72) Inventors: HIROSHI SAITO, Kanagawa (JP); KANAKO OSHIMA, Tokyo (JP); NOBUHIRO YASUI, Kanagawa (JP)

(21) Appl. No.: 18/306,098

(22) Filed: Apr. 24, 2023

Related U.S. Application Data
(63) Continuation of application No. PCT/JP2021/038611, filed on Oct. 19, 2021.

(30) Foreign Application Priority Data
Oct. 27, 2020 (JP) 2020-179540
Dec. 16, 2020 (JP) 2020-208224

(51) Int. Cl. A61C 13/00; A61C 13/08

(52) U.S. Cl. CPC A61C 13/0019; A61C 13/08; A61C 9/0053

(57) ABSTRACT

A dental prosthesis fabrication system includes: an intraoral information obtaining unit that obtains three-dimensional shape information of a tooth and color information of the tooth; a data generation unit that generates three-dimensional shape data and color data of the tooth based on the three-dimensional shape information of the tooth; a forming unit that forms a dental prosthesis based on the three-dimensional shape data of the tooth; and a coloring unit that applies color to a surface of the dental prosthesis based on the color data of the tooth.

### CROSS-REFERENCE TO RELATED APPLICATIONS

This application is a Continuation of International Patent Application No. PCT/JP2021/038611, filed Oct. 19, 2021, which claims the benefit of Japanese Patent Application No. 2020-179540, filed Oct. 27, 2020, and Japanese Patent Application No. 2020-208224, filed Dec. 16, 2020, all of which are hereby incorporated by reference herein in their entirety.

### TECHNICAL FIELD

The present disclosure relates to a dental prosthesis fabrication system for forming and coloring a dental prosthesis based on intraoral information, a dental prosthesis fabrication method, a dental prosthesis coloring method for coloring a dental prosthesis, a dental prosthesis coloring system, and a program.

### BACKGROUND ART

Conventionally, dental prostheses such as inlays, crowns, bridges, etc. have been produced by the manual labor of dental technicians, such as through casting. In contrast, CAD/CAM systems for designing dental prostheses such as inlays, crowns, bridges, etc. using computers and producing the dental prostheses through cutting and processing have attracted attention (PTL 1).

PTL 1 discloses the following: using a CAD/CAM system, three-dimensional shape information of an abutment tooth or a cavity-formed tooth, and in some cases, three-dimensional shape information of an adjacent tooth or an opposing tooth, are read; based on the read information on the tooth shape and the like, a target dental prosthesis is designed using a computer; and then a dental prosthesis is produced by setting a block-shaped material such as a resin-cured body, a ceramic sintered body, or a metal body on an automatic cutting machine, and cutting and processing the block-shaped material.

### CITATION LIST

### Patent Literature

PTL 1 Japanese Patent Laid-Open No. 2002-224142

In PTL 1, although a dental prosthesis is formed by cutting and processing a block material based on three-dimensional shape information of a tooth and the like using a CAD/CAM system, the coloring of the dental prosthesis is performed manually and is thus costly.

### SUMMARY OF INVENTION

It is an aspect of the present disclosure to provide a dental prosthesis fabrication system for forming and coloring a dental prosthesis based on intraoral information, a dental prosthesis fabrication method, a dental prosthesis coloring method for coloring a dental prosthesis, a dental prosthesis coloring system, and a program.

A dental prosthesis fabrication system according to the present disclosure includes: an intraoral information obtaining unit that obtains three-dimensional shape information of a tooth and color information of the tooth; a data generation unit that generates three-dimensional shape data of the tooth and color data of the tooth based on the three-dimensional shape information of the tooth; a forming unit that forms a dental prosthesis based on the three-dimensional shape data of the tooth; and a coloring unit that applies color to a surface of the dental prosthesis based on the color data of the tooth.

Further features of the present disclosure will become apparent from the following description of exemplary embodiments with reference to the attached drawings.

### BRIEF DESCRIPTION OF DRAWINGS

FIG. 1 is a diagram illustrating the configuration of a dental prosthesis fabrication system of the present disclosure.

FIG. 2 is a diagram illustrating a dental prosthesis generation flow according to a first embodiment of the present disclosure.

FIG. 3 is an image diagram of the dental prosthesis generation flow according to the first embodiment of the present disclosure.

FIG. 4 is a schematic diagram of an example of an apparatus that realizes each part of the dental prosthesis fabrication system according to the first embodiment of the present disclosure.

FIG. 5 is a schematic diagram of an intraoral scanner 1000 according to the first embodiment of the present disclosure.

FIG. 6 is a schematic diagram of a dental CAD 2000 according to the first embodiment of the present disclosure.

FIG. 7 is a schematic diagram of a processing flow performed by a processing apparatus 3000 according to the first embodiment of the present disclosure.

FIG. 8 is a schematic diagram of a dental CAM 4000 according to the first embodiment of the present disclosure.

FIG. 9 is a schematic diagram of a coloring apparatus 5000 according to the first embodiment of the present disclosure.

FIG. 10 is a diagram illustrating the configuration of a dental prosthesis fabrication system according to a second embodiment of the present disclosure.

FIG. 11 is a diagram illustrating a dental prosthesis generation flow according to the second embodiment of the present disclosure.

FIG. 12 is an image diagram of the dental prosthesis generation flow according to the second embodiment of the present disclosure.

FIG. 13 is a schematic diagram of an example of an apparatus that realizes each part of the dental prosthesis fabrication system according to the second embodiment of the present disclosure.

FIG. 14 is a schematic diagram of an intraoral scanner 11000 according to the second embodiment of the present disclosure.

FIG. 15 is a schematic diagram of a dental CAD 12000 according to the second embodiment of the present disclosure.

FIG. 16 is a schematic diagram of a dental CAM 13000 according to the second embodiment of the present disclosure.

FIG. 17 is a diagram describing the dental prosthesis generation flow according to the second embodiment of the present disclosure.

FIG. 18 is a schematic diagram of a coloring apparatus 14000 according to the second embodiment of the present disclosure.

FIG. 19 is a diagram describing a dental prosthesis coloring flow according to the second embodiment of the present disclosure.

### DESCRIPTION OF EMBODIMENTS

Hereinafter, preferred embodiments of the present disclosure will be described with reference to the accompanying drawings.

### First Embodiment

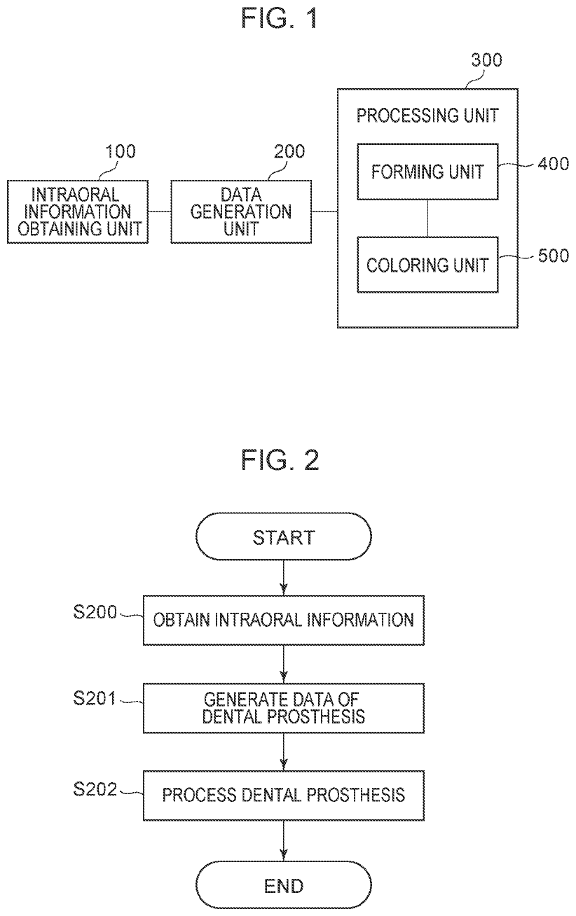

FIG. 1 illustrates the configuration of a dental prosthesis fabrication system of the present disclosure.

The dental prosthesis fabrication system of the present disclosure includes an intraoral information obtaining unit 100, which obtains intraoral information, and a data generation unit 200, which generates three-dimensional shape data and color data of a dental prosthesis based on the obtained intraoral information. The dental prosthesis fabrication system further includes a processing unit 300, which forms and colors a dental prosthesis based on the generated data. In addition, the processing unit 300 includes a forming unit 400, which forms a dental prosthesis, and a coloring unit 500, which colors the dental prosthesis.

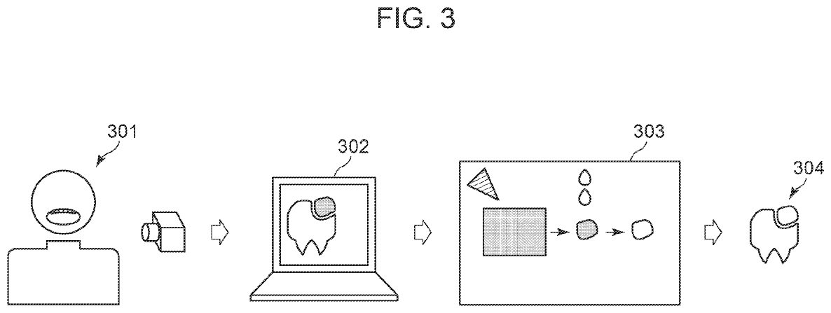

Hereinafter, a dental prosthesis generation flow performed by the dental prosthesis fabrication system, illustrated in FIG. 2, will be described with reference to an image diagram of FIG. 3.

In step S200, the intraoral information obtaining unit 100 obtains a subject's intraoral information from a storage device or the like. Information obtained by the intraoral information obtaining unit 100 includes three-dimensional information of a tooth, and color information of the tooth. The intraoral information obtaining unit 100 sends the obtained intraoral information to the data generation unit 200. Note that the intraoral information obtained by the intraoral information obtaining unit 100 here may be such that intraoral information captured using imaging means such as an intraoral scanner (see 301 of FIG. 3) is sent from an imaging device. In 301 of FIG. 3, an image of obtaining a user's intraoral information is illustrated.

In step S201, the data generation unit 200 generates three-dimensional shape data of the tooth and color data of the tooth based on the intraoral information (see 302 of FIG. 3). The data generation unit 200 generates data including three-dimensional shape information of the tooth, including missing tooth information, and color information based on the intraoral information. The data generation unit 200 may generate three-dimensional shape data of the tooth based on, for example, the difference between master information of the shape of the tooth and the sent three-dimensional shape information of the tooth. Having generated the three-dimensional shape data of the tooth and the color data of the tooth, the data generation unit 200 sends the generated data to the processing unit 300. In 302 of FIG. 3, a dental prosthesis is illustrated in a dark color, and an existing tooth is illustrated in a light color. The data generation unit 200 generates three-dimensional shape data of the tooth and color data of the tooth based on intraoral information obtained by the intraoral information obtaining unit 100. Note that the three-dimensional shape data and color data of the tooth generated by the data generation unit 200 may be correlated items of data. Although described in detail later, for example, color data of a dental prosthesis is generated based on the color information of the existing tooth and color distribution information. In such a case, because color data generated by the data generation unit 200 is based on the three-dimensional shape information and color information of the tooth, the generated three-dimensional shape data and color data are structured with a correlation between each other.

In step S202, the processing unit 300 processes a dental prosthesis based on the obtained three-dimensional shape data and color data of the dental prosthesis (see 303 of FIG. 3). Although step S202 will be described in detail later, the processing unit 300 forms a dental prosthesis by, using the forming unit 400, cutting and grinding a base material for a dental prosthesis based on the obtained three-dimensional shape data of the tooth. In addition, the processing unit 300 applies color using the coloring unit 500 based on the color data of the dental prosthesis. In 303 of FIG. 3, an image of forming a dental prosthesis from a base material for a dental prosthesis and coloring the formed dental prosthesis is illustrated. With this flow, the dental prosthesis fabrication system of the present disclosure can form and color a dental prosthesis based on intraoral information, and can generate a highly compatible dental prosthesis as illustrated in an image of 304 of FIG. 3.

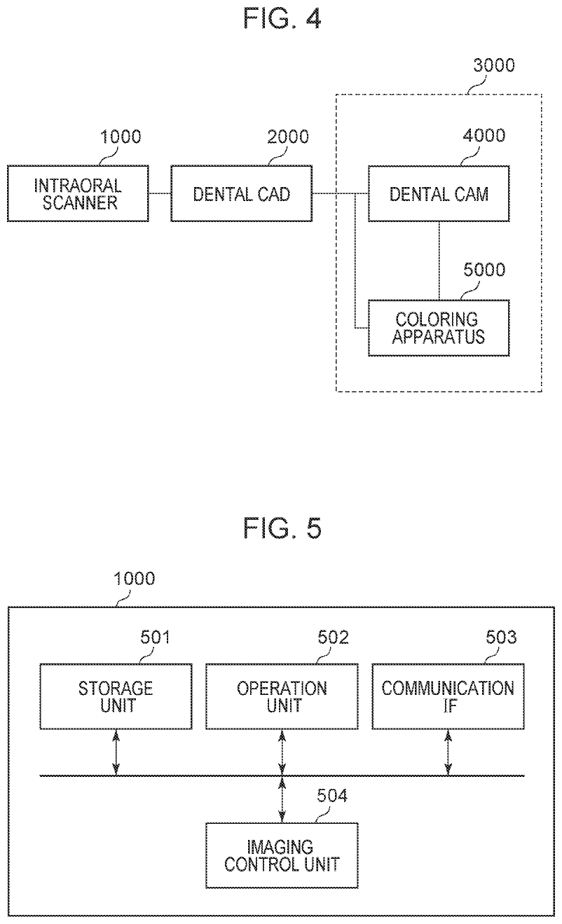

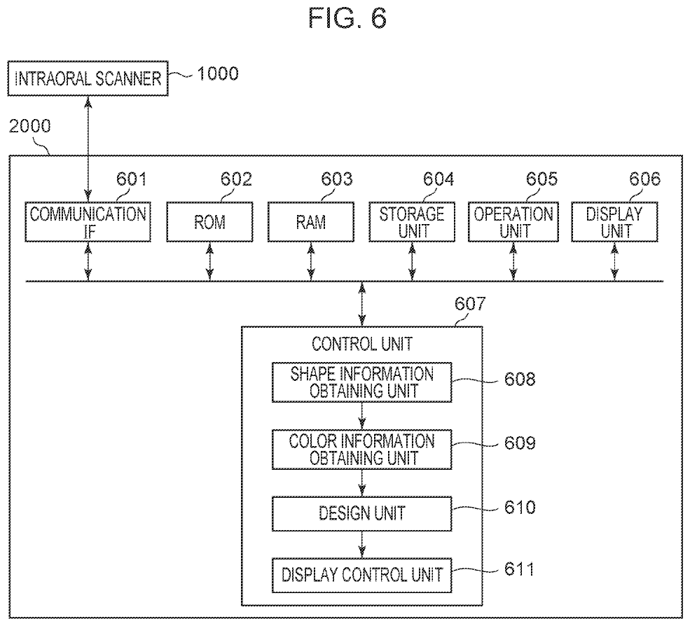

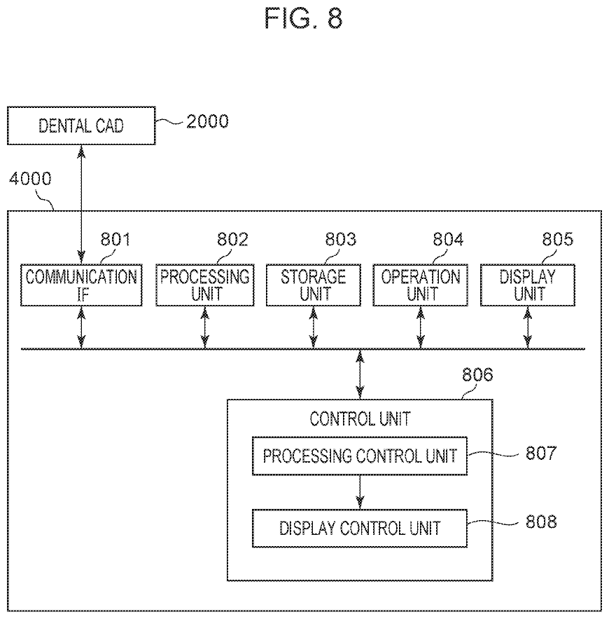

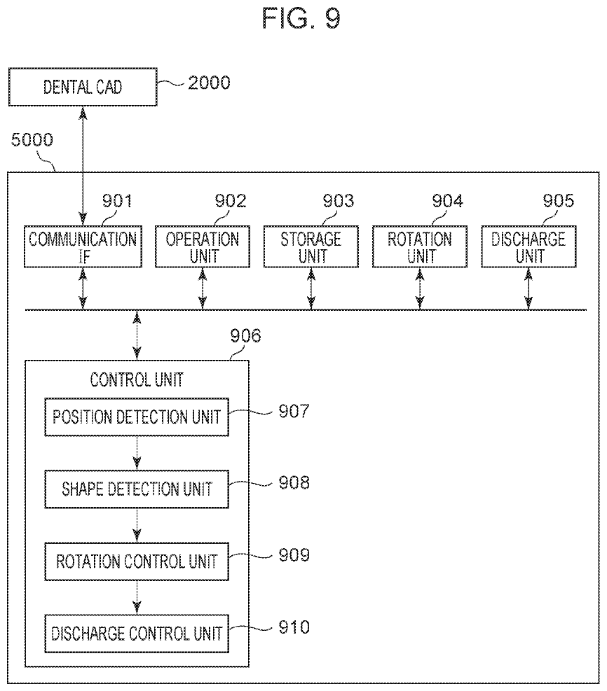

Here, an example of an apparatus that realizes each part of the dental prosthesis fabrication system will be described using FIG. 4. The function of the intraoral information obtaining unit 100 is realized by, for example, an intraoral scanner 1000 (described later using FIG. 5). Intraoral information captured by the intraoral scanner 1000 is sent to a dental CAD 2000 (described later using FIG. 6), which has the function of the data generation unit 200. Moreover, three-dimensional shape data and color data of a dental prosthesis that are generated by the dental CAD 2000 are sent to a processing apparatus 3000, which has the function of the processing unit 300. The processing apparatus 3000 includes a dental CAM 4000 (described later using FIG. 8), which has the function of the forming unit 400, and a coloring apparatus 5000 (described later using FIG. 9), which has the function of the coloring unit 500. Note that the apparatus realizing each part of the dental prosthesis fabrication system is not limited to the foregoing. Hereinafter, each apparatus included in the above-described dental prosthesis fabrication system will be described.

Intraoral Scanner 1000

First, using FIG. 5, a schematic diagram of the intraoral scanner 1000, which realizes the function of the intraoral information obtaining unit 100 in the dental prosthesis fabrication system, will be described. The intraoral scanner 1000 is equipped with a storage unit 501, an operation unit 502, a communication IF (Interface) 503, and an imaging control unit 504. The storage unit 501 stores the obtained tooth information and the like, and the operation unit 502 receives a user's operations. The communication IF 503 is realized by a LAN card or the like, and is responsible for communication with an external apparatus (such as the dental CAD 2000). The imaging control unit 504 obtains three-dimensional shape information and color information of a tooth. Here, the three-dimensional shape information and color information of the tooth may be obtained simultaneously or separately by the imaging control unit 504. In addition, the three-dimensional shape information and color information of the tooth obtained by the imaging control unit 504 may be constructed from separate devices, each of which is independent of the other.

The three-dimensional shape information and color information of the tooth, obtained by the imaging control unit 504, are stored in the storage unit 501, and are sent to the dental CAD 2000 using the communication IF 503. Note that the intraoral information obtaining unit 100 may be realized by an apparatus that obtains pre-captured intraoral information from a storage device or the like. In addition, the intraoral scanner 1000 is a scanner for obtaining intraoral information, and need not be inserted into the oral cavity for imaging. For example, For example, an intraoral seal may be taken and scanned to obtain three-dimensional shape information of a tooth.

Dental CAD 2000

Next, an example of a schematic diagram of the dental CAD 2000, which realizes the data generation unit 200 in the dental prosthesis fabrication system, will be discussed. As in FIG. 6, the dental CAD 2000 is equipped with a communication IF 601, a ROM 602, a RAM 603, a storage unit 604, an operation unit 605, a display unit 606, and a control unit 607. The communication IF 601 is realized by a LAN card or the like, and is responsible for communication with the intraoral scanner 1000 and the processing apparatus 3000, which are external. Note that, if it is unnecessary to perform communication, the communication IF 601 is not essential as a configuration. The ROM 602 is realized by a non-volatile memory or the like, and stores various programs and the like. The RAM 603 is realized by a volatile memory or the like, and temporarily stores various types of information. The storage unit 604 is realized by an HDD (Hard Disk Drive), an SSD (Solid State Drive), or the like, and stores various types of information. The operation unit 605 is realized by a keyboard, a mouse, and the like. The display unit 606 is realized by a display or the like, and displays various types of information to a user. The operation unit 605 and the display unit 606 may function as configurations of the dental CAD 2000, as illustrated in the drawing, or may be composed of an apparatus different from the dental CAD 2000. The control unit 607 includes a shape information obtaining unit 608 for teeth, a color information obtaining unit 609 for teeth, a design unit 610, and a display control unit 611. The dental CAD 2000 receives the three-dimensional shape information and color information of the tooth from the intraoral scanner 1000 via the communication IF 601. In the control unit 607, the three-dimensional shape information and color information of the tooth are obtained by the shape information obtaining unit 608 and the color information obtaining unit 609, respectively, and these items of information are integrated for design by the design unit 610 to generate three-dimensional shape data and color data of the tooth. Note that the shape information obtaining unit 608 and the color information obtaining unit 609 may be replaced by an obtaining unit that has both functions. The three-dimensional shape data and color data of the tooth, designed by the design unit 610, are displayed on the display unit 606 through the display control unit 611. The design unit 610 may perform design through input by the operation unit 605 or the like. The three-dimensional shape data and color data designed by the design unit 610 are suitably recorded in the ROM 602, the RAM 603, and the storage unit 604. The three-dimensional shape data and color data of the tooth, designed by the design unit 610, are sent to the processing apparatus 3000 via the communication IF 601.

Here, the design unit 610 may obtain, based on the three-dimensional shape information and the color information, brightness data of a tooth on which the dental prosthesis is placed, a tooth in the vicinity of the position where the dental prosthesis is placed, or a tooth corresponding to a tooth on which the dental prosthesis is placed, and may generate color data based on the obtained brightness data. In addition, color data generated by the design unit 610 may be such that, based on three-dimensional shape information and color information, predicted appearance data of the dental prosthesis is obtained from outside the patient's oral cavity based on the position or orientation of placing the dental prosthesis, and color data is generated based on the predicted appearance data. Here, the color data designed by the design unit 610 may include a color having a lower hue b* than the hue b* in the chromaticity coordinates defined by the L*a*b* color system of CIE 1976. Of the color data designed by the design unit 610, a color having the lower hue b* is applied to a portion of the dental prosthesis for color matching. It is more desirable to apply the color to the tip, which is a portion of the dental prosthesis, and its nearby areas for color matching, as it provides superior aesthetic appeal. The color data may be determined based on at least one of the placement information of a light source, the intensity of light emitted by the light source, the frequency of the light, or the color shade of the light. Moreover, there may be multiple color data candidates to be displayed on the display unit 606 using the display control unit 611. Then, the user may be able to select a color from the multiple color data candidates displayed on the display unit 606 using the operation unit 605 or the like.

In addition, the multiple color data candidates displayed on the display unit 606 may be displayed along with a matching score with at least one of color information of a tooth on which the dental prosthesis is placed, a tooth in the vicinity of the position where the dental prosthesis is placed, or a tooth corresponding to a tooth on which the dental prosthesis is placed.

Furthermore, regarding color data to be designed by the design unit 610, color data exceeding a certain luminance value need not be generated by comparing color information of a tooth with the certain luminance value. Using the coloring apparatus 5000, which realizes the function of the later-described coloring unit 500 based on the generated color data, the dental prosthesis is colored based on color data not exceeding the certain luminance value. Color reproducibility is improved by excluding data that exceeds the certain luminance value using the design unit 610.

Processing Apparatus 3000

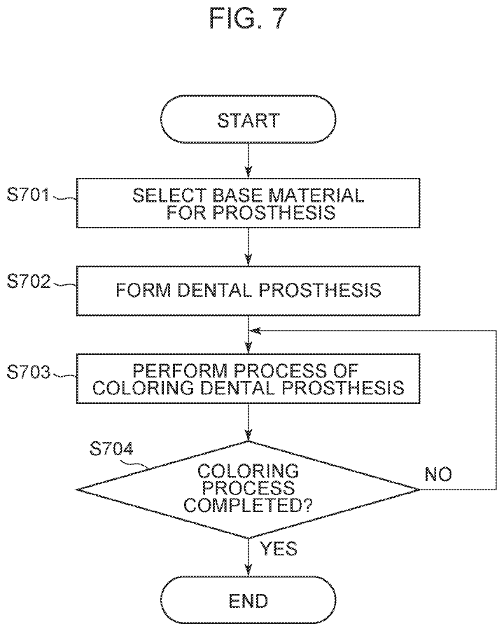

Here is an example of the processing apparatus 3000, which realizes the function of the processing unit 300 in the dental prosthesis fabrication system. First, a processing flow performed by the processing apparatus 3000 will be described using FIG. 7. First, in step S701, a base material for a dental prosthesis is selected based on three-dimensional shape data and color data of a tooth, generated by the dental CAD 2000, which realizes the function of the data generation unit 200. Note that this step may be suitably omitted in the case where, for example, the user selects a base material. In step S702, the processing apparatus 3000 sends the three-dimensional shape data of the tooth to the dental CAM 4000, which realizes the function of the forming unit 400, and the dental CAM 4000 forms a dental prosthesis. In step S703, the processing apparatus 3000 sends the color data to the coloring apparatus 5000. Based on the received color data, the coloring apparatus 5000 colors the dental prosthesis formed by the dental CAM 4000. When the coloring performed by the coloring apparatus 5000 is completed in step S704, this flow ends. Although the case where the dental CAM 4000 and the coloring apparatus 5000 are composed of different apparatuses has been described in this flow, the processing apparatus 3000 which integrates these apparatuses may form and color a dental prosthesis. Since the dental prosthesis fabrication system includes the above-mentioned apparatuses, a dental prosthesis can be formed and colored based on the captured and obtained intraoral information. Hereinafter, the apparatus configuration will be described by dividing it into the dental CAM 4000 and the coloring apparatus 5000.

Dental CAM 4000

Using FIG. 8, an example of the dental CAM 4000, which realizes the function of the forming unit 400 in the dental prosthesis fabrication system, will be discussed. The dental CAM 4000 includes a communication IF 801, a processing unit 802, a storage unit 803, an operation unit 804, a display unit 805, and a control unit 806. The control unit 806 is equipped with a processing control unit 807 and a display control unit 808. The dental CAM 4000 receives three-dimensional shape data and color data sent by the dental CAD 2000 via the communication IF 801. The received three-dimensional shape data and color data are stored in the storage unit 803. Based on the received three-dimensional shape data, the dental CAM 4000 controls the processing unit 802 through the processing control unit 807 included in the control unit 806, to process a base material for a dental prosthesis and form a dental prosthesis. The processing and forming result obtained by the processing unit 802 can be displayed on the display unit 805 through the display control unit 808. Here, the dental CAM 4000 is able to select a desired base material for a prosthesis based on the received three-dimensional shape data and color data. It is desirable that a base material for a prosthesis selected by the dental CAM 4000 be a base material for a prosthesis close to the color data of the tooth received by the dental CAM 4000 from the dental CAD 2000. For example, a base material selected for a dental prosthesis is a base material for a prosthesis that has a high whiteness close to the color data. Moreover, a base material for a dental prosthesis may also contain a ceramic or a resin. Here, the processing unit 802 may form a dental prosthesis by cutting and/or grinding a base material for a prosthesis. Alternatively, the processing unit 802 may process and form a dental prosthesis by repeatedly and sequentially sintering or melting the raw material to solidify through light irradiation of a base material for a dental prosthesis. The processing unit 802 may also form a dental prosthesis by additive manufacturing. Moreover, the control unit 806 may be controlled through the operation unit 804.

Coloring Apparatus 5000

Using FIG. 9, an example of the coloring apparatus 5000, which realizes the function of the coloring unit 500 in the dental prosthesis fabrication system, will be discussed. The coloring apparatus 5000 is equipped with a communication IF 901, an operation unit 902, a storage unit 903, a rotation unit 904, a discharge unit 905, and a control unit 906. The control unit 906 is equipped with a position detection unit 907, a shape detection unit 908, a rotation control unit 909, and a discharge control unit 910. The coloring apparatus 5000 receives three-dimensional shape data and color data of a tooth sent by the dental CAD 2000 via the communication IF 901. The received three-dimensional shape data and color data are recorded in the storage unit 903. The coloring apparatus 5000 holds a dental prosthesis, which is processed and formed by the dental CAM 4000, with the rotation unit 904. The position detection unit 907 detects the position data of the dental prosthesis processed and formed by the dental CAM 4000. The shape detection unit 908 detects the shape using the position data of the dental prosthesis detected by the position detection unit 907 or the received three-dimensional shape data. Combining the position data detected by the position detection unit 907 with the received three-dimensional shape data improves the accuracy of detecting the shape of the dental prosthesis using the shape detection unit 908. Detection of the shape of the dental prosthesis using the shape detection unit 908 may be replaced by reception of the three-dimensional shape data. The coloring apparatus 5000 colors the dental prosthesis, processed and formed by the dental CAM 4000, with a coloring material while controlling the rotation unit 904 through the rotation control unit 909 and controlling the discharge unit 905 through the discharge control unit 910 according to the shape of the dental prosthesis detected by the shape detection unit 908.

Note that the discharge method of the discharge unit 905 may be either inkjet or spray. Here, inkjet may be used by the discharge unit 905 when the amount of coloring material is small. Meanwhile, a spray may be used as the discharge unit 905 when the amount of coloring material is large. Alternatively, the discharge unit 905 may include inkjet and spray mechanisms that are switchable. In addition, two or more types of coloring materials pertaining to the coloring of the dental prosthesis of the coloring apparatus 5000 may be used to improve the reproducibility of the color data of the dental prosthesis. Furthermore, the coloring apparatus 5000 may have an application unit (not illustrated) for applying a coloring material to the dental prosthesis. In the case where the coloring apparatus 5000 applies a coloring material, the application unit may use a plurality of different coloring materials to perform multi-layer coating. Multi-layer coating performed by the application unit improves the reproducibility of coloring with respect to the color data for the dental prosthesis. Coloring materials having different refractive indices may be used as the plurality of coloring materials. By using coloring materials with different refractive indices for coloring the dental prosthesis, the reflectance is increased, and, as a result, the coloring reproducibility can be realized with a small amount of application. Also, a coloring material for coloring the dental prosthesis by using the coloring apparatus 5000 may be selected by referring to a lookup table that links color data of a tooth to a coloring material. If the coloring apparatus 5000 has the lookup table in advance, it is possible to reduce the computational cost associated with determining the coloring material. The coloring material may contain any of B, Si, or resin. A wide color space can be realized by containing either B, Si, or resin in the coloring material for coloring the dental prosthesis.

Moreover, a coloring material for coloring the dental prosthesis by using the coloring apparatus 5000 may contain a light-scattering material. Through coloring with a coloring material containing a light-scattering material, the coloring reproducibility can be realized with a yet smaller amount of application. A light-scattering material having a high refractive index may be used for the light-scattering material. The light-scattering material having a high refractive index may contain at least one of TiO₂, SiO₂, or ZrO₂.

### EXAMPLES

Hereinafter, the present disclosure will be described in more detail with reference to examples, but the invention is not limited by the following examples.

### Example 1

Three-dimensional modeling was performed by irradiating the raw material with a Yb fiber laser using three-dimensional shape data of a tooth. Powder 1 in Table 1 was used as the raw material. A three-dimensional shape measurement machine was used to confirm that a prosthesis that is the same as or similar to the three-dimensional shape data of the tooth was modeled. The modeled prosthesis was colored with a coloring material using an inkjet printer.

TABLE 1

| | | Base material | | Absorbent | |
|---|---|---|---|---|---|
| | | | Mixing | | Mixing |
| | Powder | | ratio | | ratio |
| | name | Type | [vol %] | Type | [vol %] |
| Example | Powder | 70.5SiO₂•29.5Li₂CO₃ | 97.13 | SiO | 2.87 |
| 1 | 1 | | | | |
| Example | Powder | Al₂O₃ | 64.40 | Ti₂O₃ | 2.87 |
| 2 | 2 | Gd₂O₃ | 32.73 | — | — |

### Example 2

As in Example 1, a prosthesis was produced using powder 2 as the raw material.

It was confirmed that the prostheses of Examples 1 and 2 are usable as dental prostheses.

Modifications

A computer program that realizes the functions of the above-described embodiment is supplied to a computer via a network or a storage medium (not illustrated) to cause the computer to execute the computer program. It is a computer program for causing a computer to execute a method of generating a dental prosthesis by implementing each part of the dental prosthesis fabrication system described above. For example, it is a program for causing a forming apparatus 4000 to execute a step of forming a dental prosthesis by using three-dimensional shape data of a tooth generated based on three-dimensional shape information of the tooth present in the tooth, and causing the coloring apparatus 5000 to apply color to a surface of the dental prosthesis using color data of the tooth generated based on color information of the tooth present in the tooth.

### Second Embodiment

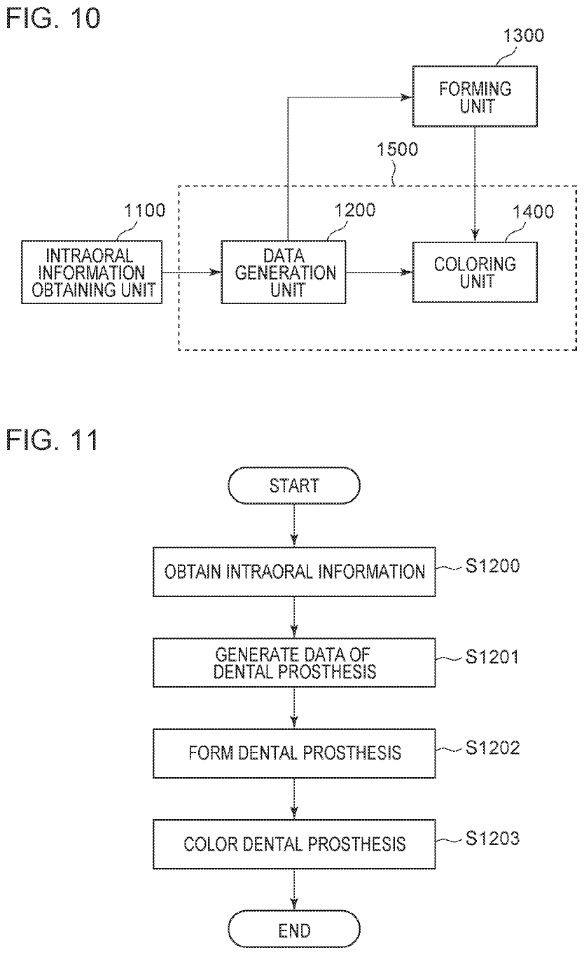

FIG. 10 illustrates the configuration of a dental prosthesis fabrication system according to a present embodiment.

The dental prosthesis fabrication system of the present disclosure includes an intraoral information obtaining unit 1100, which obtains intraoral information, and a data generation unit 1200, which generates three-dimensional shape data and color data of a dental prosthesis based on the obtained intraoral information. The dental prosthesis fabrication system further includes a forming unit 1300, which forms a dental prosthesis based on the generated three-dimensional shape data, and a coloring unit 1400, which applies color to the surface of the formed dental prosthesis based on the generated color data. Here, the data generation unit 1200 of the present disclosure and the coloring unit 1400 which applies color based on color data generated by the data generation unit 1200 function as a dental prosthesis coloring system 1500. That is, the coloring system 1500 includes the data generation unit 1200, which generates color data of a tooth based on color information of the tooth, and the coloring unit 1400, which applies color to the surface of the formed dental prosthesis based on the color data. Moreover, the forming unit 1300 and the coloring unit 1400 may be composed of the same apparatus performing both processes.

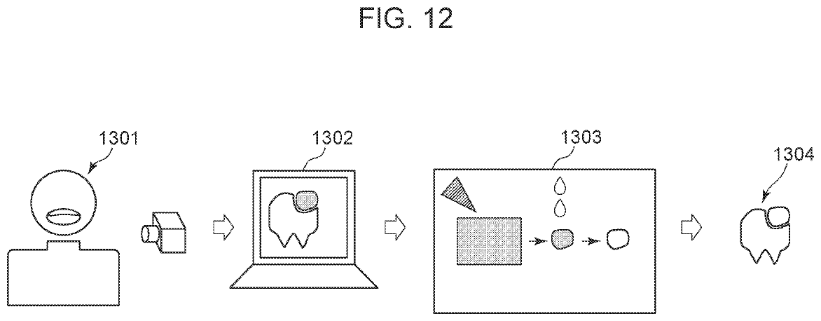

Hereinafter, a dental prosthesis generation flow performed by the dental prosthesis fabrication system, illustrated in FIG. 11, will be described with reference to an image diagram of FIG. 12.

In step S1200, the intraoral information obtaining unit 1100 obtains a subject's intraoral information from a storage device or the like. The information obtained by the intraoral information obtaining unit 1100 includes three-dimensional shape information of a tooth and color information of the tooth. The intraoral information obtaining unit 1100 sends the obtained intraoral information to the data generation unit 1200. Note that the intraoral information obtained by the intraoral information obtaining unit 1100 here may be information that is captured using imaging means such as an intraoral scanner (see 1301 of FIG. 12) and that is sent from an imaging device. In 1301 of FIG. 12, an image of obtaining a user's intraoral information is illustrated.

In step S1201, the data generation unit 1200 generates three-dimensional shape data of the tooth and color data of the tooth based on the intraoral information (see 1302 of FIG. 12). The data generation unit 1200 generates data including three-dimensional shape information of the tooth, including missing tooth information or the like, and color information based on the intraoral information. The data generation unit 1200 may generate three-dimensional shape data of the tooth based on, for example, the difference between master information of the shape of the tooth and the sent three-dimensional shape information of the tooth. Having generated the three-dimensional shape data of the tooth and the color data of the tooth, the data generation unit 1200 sends the generated three-dimensional shape data to the forming unit 1300, and sends the color data to the coloring unit 1400. In 1302 of FIG. 12, a dental prosthesis is illustrated in a dark color, and an existing tooth is illustrated in a light color.

The data generation unit 1200 generates the three-dimensional shape data of the tooth and the color data of the tooth based on intraoral information obtained by the intraoral information obtaining unit 1100. Note that the three-dimensional shape data and color data of the tooth generated by the data generation unit 1200 may be correlated items of data. Although described in detail later, for example, color data of a dental prosthesis is generated based on the color information of the existing tooth and color distribution information. In such a case, because color data generated by the data generation unit 1200 is based on the three-dimensional shape information and color information of the tooth, the generated three-dimensional shape data and color data are structured with a correlation between each other.

In step S1202, the forming unit 1300 forms a dental prosthesis by cutting and grinding, using the forming unit 1300, a base material for a dental prosthesis based on the obtained three-dimensional shape data of the tooth. After forming a dental prosthesis using the forming unit 1300, the formed dental prosthesis is sent to the coloring unit 1400.

In step S1203, the coloring unit 1400 applies color to the surface of the dental prosthesis obtained from the forming unit 1300 based on the obtained color data of the dental prosthesis. In 1303 of FIG. 12, an image of forming a dental prosthesis from a base material for a dental prosthesis using the forming unit 1300, and coloring the formed dental prosthesis using the coloring unit 1400 is illustrated.

With this flow, the dental prosthesis coloring system 1500 of the present disclosure can color a formed dental prosthesis. The coloring of the dental prosthesis using the coloring system 1500 can generate a highly compatible dental prosthesis as illustrated in an image of 1304 of FIG. 12.

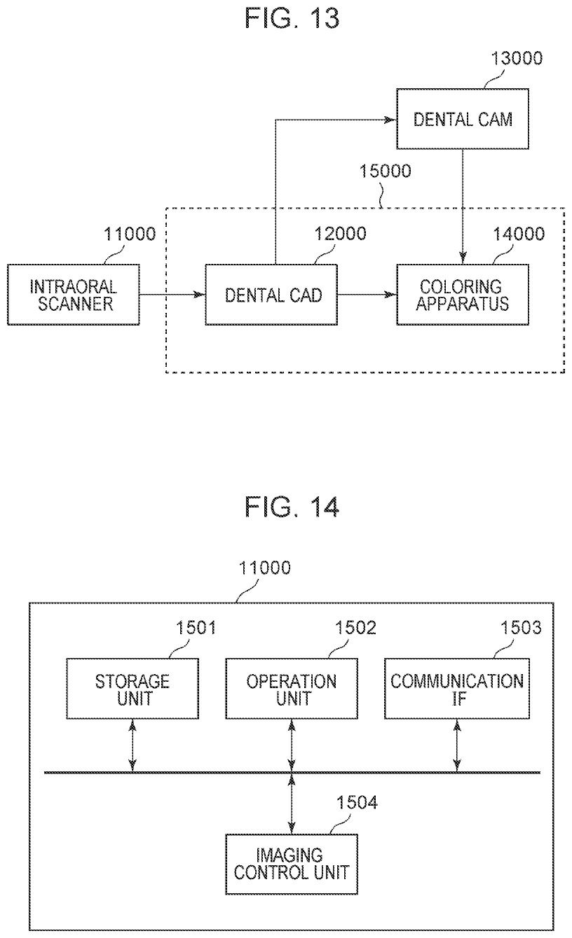

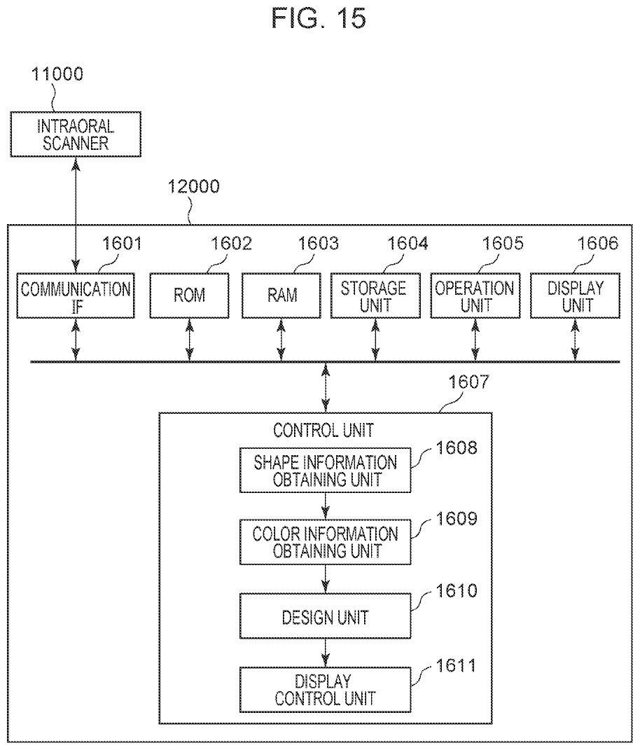

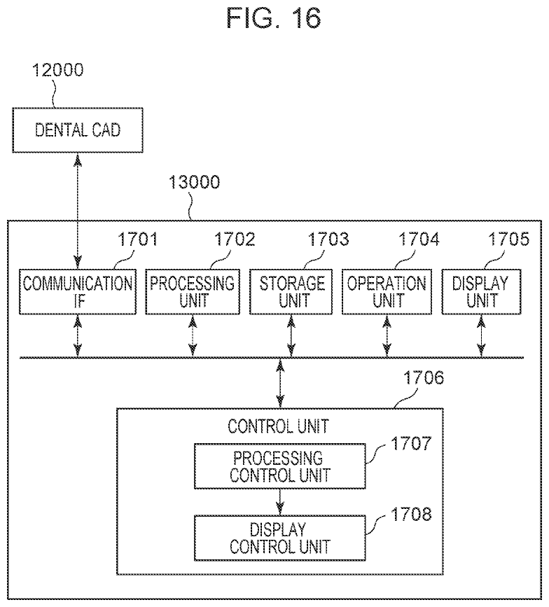

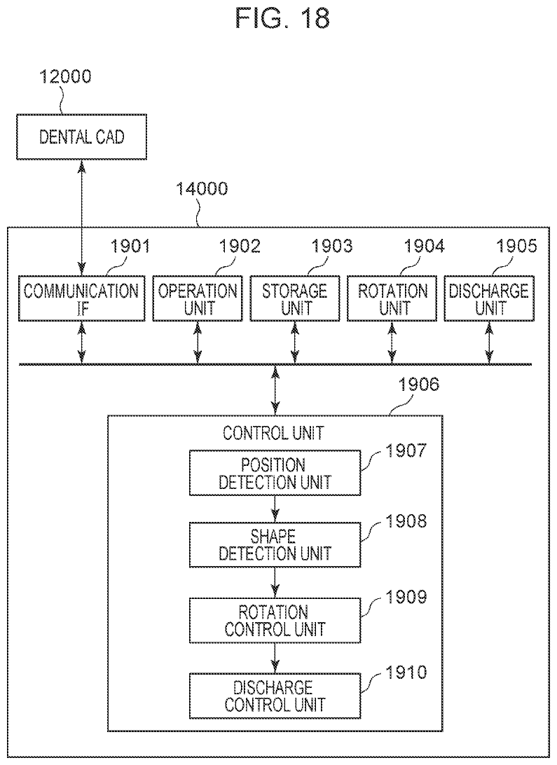

Here, an example of an apparatus that realizes each part of the dental prosthesis fabrication system will be described using FIG. 13. The function of the intraoral information obtaining unit 1100 is realized by, for example, an intraoral scanner 11000 (described later using FIG. 14). Intraoral information captured by the intraoral scanner 11000 is sent to a dental CAD 12000 (described later using FIG. 15), which has the function of the data generation unit 1200. Moreover, three-dimensional shape data of a dental prosthesis generated by the dental CAD 12000 is sent to a dental CAM 13000 (described later using FIG. 16), which has the function of the forming unit 1300. Furthermore, color data generated by the dental CAD 12000 is sent to a coloring apparatus 14000 (described later using FIG. 18), which has the function of the coloring unit 1400. In addition, the dental CAD 12000 and the coloring apparatus 14000 may function as a dental prosthesis coloring system 15000 integrating these apparatuses. Note that the apparatus realizing each part of the dental prosthesis fabrication system is not limited to the foregoing. Hereinafter, each apparatus included in the above-described dental prosthesis fabrication system will be described.

Intraoral Scanner 11000

First, using FIG. 14, a schematic diagram of the intraoral scanner 11000, which realizes the function of the intraoral information obtaining unit 1100 in the dental prosthesis fabrication system, will be described. The intraoral scanner 11000 is equipped with a storage unit 1501, an operation unit 1502, a communication IF (Interface) 1503, and an imaging control unit 1504. The storage unit 1501 stores the obtained tooth information and the like, and the operation unit 1502 receives a user's operations. The communication IF 503 is realized by a LAN card or the like, and is responsible for communication with an external apparatus (such as the dental CAD 12000). The imaging control unit 504 obtains three-dimensional shape information of a tooth, and color information of the tooth. Here, the three-dimensional shape information and color information of the tooth may be obtained simultaneously or separately by the imaging control unit 504. In addition, the three-dimensional shape information and color information of the tooth obtained by the imaging control unit 504 may be constructed from separate devices, each of which is independent of the other.

The three-dimensional shape information and color information of the tooth, obtained by the imaging control unit 504, are stored in the storage unit 1501, and are sent to the dental CAD 12000 using the communication IF 503. Note that the intraoral information obtaining unit 1100 may be realized by an apparatus that obtains pre-captured intraoral information from a storage device or the like. In addition, the intraoral scanner 11000 is a scanner for obtaining intraoral information, and need not be inserted into the oral cavity for imaging. For example, the intraoral information obtaining unit 1100 may take an intraoral seal, which is then scanned to obtain three-dimensional shape information of a tooth.

Dental CAD 12000

Next, an example of a schematic diagram of the dental CAD 12000, which realizes the data generation unit 1200 in the dental prosthesis fabrication system, will be discussed. As illustrated in FIG. 15, the dental CAD 12000 is equipped with a communication IF 1601, a ROM 1602, a RAM 1603, a storage unit 1604, an operation unit 1605, a display unit 1606, and a control unit 1607.

The communication IF 1601 is realized by a LAN card or the like, and is responsible for communication with the intraoral scanner 11000, the dental CAM 13000, and the coloring apparatus 14000, which are external. Note that, if it is unnecessary to perform communication, the communication IF 1601 is not essential as a configuration. The ROM 1602 is realized by a non-volatile memory or the like, and stores various programs and the like. The RAM 1603 is realized by a volatile memory or the like, and temporarily stores various types of information. The storage unit 1604 is realized by an HDD (Hard Disk Drive), an SSD (Solid State Drive), or the like, and stores various types of information. The operation unit 1605 is realized by a keyboard, a mouse, and the like. The display unit 1606 is realized by a display or the like, and displays various types of information to a user. The operation unit 1605 and the display unit 1606 may function as configurations of the dental CAD 12000, as illustrated in the drawing, or may be composed of an apparatus different from the dental CAD 12000. The control unit 1607 includes a shape information obtaining unit 1608 for teeth, a color information obtaining unit 1609 for teeth, a design unit 1610, and a display control unit 1611. The dental CAD 12000 receives three-dimensional shape information and color information of a tooth from the intraoral scanner 11000 via the communication IF 1601. In the control unit 1607, the three-dimensional shape information and color information of a tooth are obtained by the shape information obtaining unit 1608 and the color information obtaining unit 1609, respectively, and these items of information are integrated for design by the design unit 1610 to generate three-dimensional shape data and color data of the tooth. Note that the shape information obtaining unit 1608 and the color information obtaining unit 1609 may be replaced by an obtaining unit that has both functions. The three-dimensional shape data and color data of the tooth, designed by the design unit 1610, are displayed on the display unit 1606 through the display control unit 1611. The design unit 1610 may perform design through input by the operation unit 1605 or the like. The three-dimensional shape data and color data designed by the design unit 1610 are suitably recorded in the ROM 1602, the RAM 1603, and the storage unit 1604. The three-dimensional shape data of the tooth, designed by the design unit 1610, is sent to the dental CAM 13000 via the communication IF, and the color data of the tooth is sent to the coloring apparatus 14000. Here, the design unit 1610 may obtain, based on the three-dimensional shape information and the color information, brightness data of a tooth on which the dental prosthesis is placed, a tooth in the vicinity of the position where the dental prosthesis is placed, or a tooth corresponding to a tooth on which the dental prosthesis is placed, and may generate color data based on the obtained brightness data. In addition, color data generated by the design unit 1610 may be such that, based on three-dimensional shape information and color information, predicted appearance data of the dental prosthesis is obtained from outside the patient's oral cavity based on the position or orientation of placing the dental prosthesis, and color data is generated based on the predicted appearance data. Here, the color data designed by the design unit 1610 may include a color having a lower hue b* than the hue b* in the chromaticity coordinates defined by the L*a*b* color system of CIE 1976. Of the color data designed by the design unit 1610, a color having the lower hue b* is applied to a portion of the dental prosthesis for color matching. It is more desirable to apply the color to the tip, which is a portion of the dental prosthesis, and its nearby areas for color matching, as it provides superior aesthetic appeal. In the design unit 1610, the color data may be determined based on at least one of the placement information of a light source, the intensity of light emitted by the light source, the frequency of the light, or the color shade of the light. Moreover, there may be multiple color data candidates to be displayed on the display unit 1606 using the display control unit 1611. Then, the user may be able to select color data from the multiple color data candidates displayed on the display unit 1606 using the operation unit 1605 or the like.

In addition, the multiple color data candidates displayed on the display unit 1606 may be displayed along with a matching score with at least one of color information of a tooth on which the dental prosthesis is placed, a tooth in the vicinity of the position where the dental prosthesis is placed, or a tooth corresponding to a tooth on which the dental prosthesis is placed.

Furthermore, the design unit 1610 need not generate color data exceeding a certain luminance value by comparing color information of a tooth with the certain luminance value. By using the coloring apparatus 14000, which realizes the function of the later-described coloring unit 1400 based on the generated color data, the dental prosthesis is colored based on color data not exceeding the certain luminance value. Color reproducibility is improved by excluding color data that exceeds the certain luminance value by the design unit 1610.

Dental CAM 13000

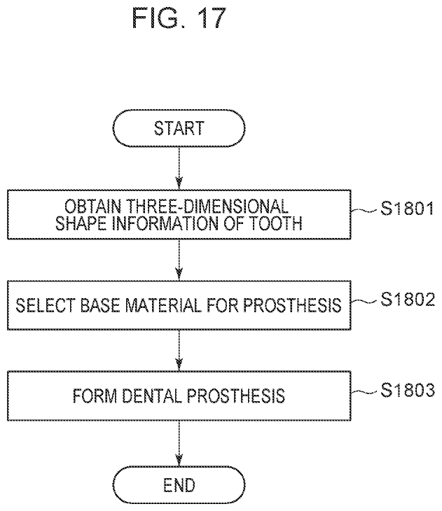

An example of the configuration of the dental CAM 13000 will be described using FIG. 16, and a step of forming a dental prosthesis will be described using FIG. 17.

The dental CAM 13000 is equipped with a communication IF 1701, a processing unit 1702, a storage unit 1703, an operation unit 1704, a display unit 1705, and a control unit 1706. The control unit 1706 is equipped with a processing control unit 1707 and a display control unit 1708.

In step S1801, the dental CAM 13000 receives three-dimensional shape data generated by the dental CAD 12000 via the communication IF 1801. The received three-dimensional shape data is stored in the storage unit 1803. Moreover, the dental CAM 13000 may further obtain color data of the tooth. The color data of the tooth is used in a later-described step.

In step S1802, the dental CAM 13000 selects a desired base material for a dental prosthesis based on the received three-dimensional shape data and color data. Selection of a base material for a dental prosthesis may be replaced by a user's selection of a base material. In addition, this step may be suitably omitted in the case where, for example, a base material for a prosthesis has been set in advance. Here, it is desirable that a base material for a prosthesis selected by the dental CAM 13000 be a base material for a prosthesis that is close to the color data of the tooth received by the dental CAM 13000 from the dental CAD 12000. For example, a base material selected for a dental prosthesis is a base material for a prosthesis that has a high whiteness close to the color data. Moreover, a base material for a dental prosthesis may also contain a ceramic and/or a resin.

In step S1803, the dental CAM 13000 controls the processing unit 1702 through the processing control unit 1707 included in the control unit 1706 based on the received three-dimensional shape data to process a base material for a dental prosthesis, thereby forming a dental prosthesis. The processing and forming result obtained by the processing unit 1702 can be displayed on the display unit 1705 through the display control unit 1708. Here, the processing unit 1702 may form a dental prosthesis by cutting and/or grinding a base material for a prosthesis. Alternatively, the processing unit 1702 may process and form a dental prosthesis by repeatedly and sequentially sintering or melting the raw material to solidify through light irradiation of a base material for a dental prosthesis. The processing unit 1702 may also form a dental prosthesis by additive manufacturing. Moreover, the control unit 1706 may be controlled through the operation unit 1704. The dental prosthesis formed by the dental CAM 13000 is used in a coloring step performed by the coloring apparatus 14000.

Coloring Apparatus 14000

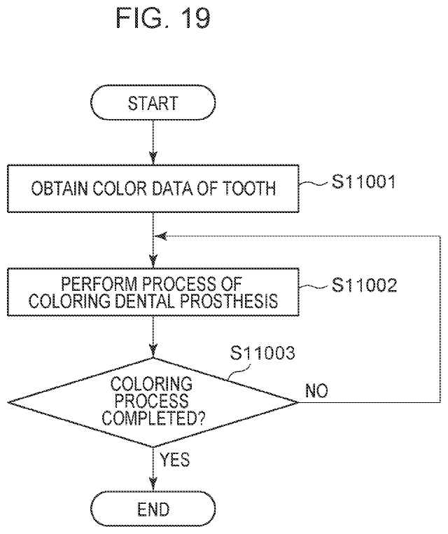

An example of the coloring apparatus 14000, which realizes the function of the coloring unit 1400 in the dental prosthesis fabrication system, will be described using FIG. 18, and a dental prosthesis coloring step including this apparatus will be described using FIG. 19.

The coloring apparatus 14000 is equipped with a communication IF 1901, an operation unit 1902, a storage unit 1903, a rotation unit 1904, a discharge unit 1905, and a control unit 1906. The control unit 1906 is equipped with a position detection unit 1907, a shape detection unit 1908, a rotation control unit 1909, and a discharge control unit 1910.

Hereinafter, a specific example of a step of coloring a formed dental prosthesis based on color data generated by the data generation unit 1200 will be described using FIG. 19.

In step S11001, the coloring apparatus 14000 receives color data of a tooth generated by the dental CAD 12000 via the communication IF 1901.

The coloring apparatus 14000 records the received color data in the storage unit 1903. The coloring apparatus 14000 holds a dental prosthesis, which is processed and formed by the dental CAM 13000, with the rotation unit 1904. The position detection unit 1907 detects the position data of the dental prosthesis processed and formed by the dental CAM 13000. The shape detection unit 1908 detects the shape of the dental prosthesis by receiving the position data of the dental prosthesis detected by the position detection unit 1907 or the three-dimensional shape data from the dental CAD 12000. Combining the position data detected by the position detection unit 1907 with the received three-dimensional shape data improves the accuracy of detecting the shape of the dental prosthesis using the shape detection unit 1908. Detection of the shape of the dental prosthesis using the shape detection unit 1908 may be replaced by reception of the three-dimensional shape data.

In step S11002, the coloring apparatus 14000 applies color to the surface of the dental prosthesis formed by the forming apparatus 13000 based on the color data generated by the dental CAD 12000. Specifically, the coloring apparatus 14000 colors the dental prosthesis, processed and formed by the dental CAM 13000, with a coloring material based on the color data while controlling the rotation unit 1904 through the rotation control unit 1909 and controlling the discharge unit 1905 through the discharge control unit 1910 according to the shape of the dental prosthesis detected by the shape detection unit 1908. When the dental prosthesis is colored, the process proceeds to step S11003. Note that the discharge method of the discharge unit 1905 may be either inkjet or spray. Here, inkjet may be used by the discharge unit 1905 when the amount of coloring material is small. Meanwhile, a spray may be used as the discharge unit 1905 when the amount of coloring material is large. Alternatively, the discharge unit 1905 may include inkjet and spray mechanisms that are switchable. In addition, two or more types of coloring materials pertaining to the coloring of the dental prosthesis of the coloring apparatus 14000 may be used to improve the reproducibility of the color data of the dental prosthesis. Furthermore, the coloring apparatus 14000 may have an application unit (not illustrated) for applying a coloring material to the dental prosthesis. In the case where the coloring apparatus 14000 applies a coloring material, the application unit may use a plurality of different coloring materials to perform multi-layer coating. Multi-layer coating performed by the application unit improves the reproducibility of coloring with respect to the color data for the dental prosthesis. Coloring materials having different refractive indices may be used as the plurality of coloring materials. By using coloring materials with different refractive indices for coloring the dental prosthesis, the reflectance is increased, and, as a result, the coloring reproducibility can be realized with a small amount of application. Also, a coloring material for coloring the dental prosthesis by using the coloring apparatus 14000 may be selected by referring to a lookup table that links color data of a tooth to a coloring material. If the coloring apparatus 14000 has the lookup table in advance, it is possible to reduce the computational cost associated with determining the coloring material. The coloring material may contain any of B, Si, or resin. A wide color space can be realized by containing either B, Si, or resin in the coloring material for coloring the dental prosthesis.

Moreover, a coloring material for coloring the dental prosthesis by using the coloring apparatus 14000 may contain a light-scattering material. Through coloring with a coloring material containing a light-scattering material, the coloring reproducibility can be realized with a yet smaller amount of application. A light-scattering material having a high refractive index may be used for the light-scattering material. The light-scattering material having a high refractive index may include at least one of TiO₂, SiO₂, or ZrO₂.

In step S11003, the coloring apparatus 14000 determines whether the coloring process has been completed. When it is determined that the coloring process has been completed, the process ends; and, when it is determined that the coloring process has not been completed, the process proceeds to step S11002, where a coloring process is performed.

Modifications

The present disclosure is also realized by performing the following process. That is, it is a process of supplying software (a program) that realizes the functions of the above-described embodiments to a system or apparatus via a network or various storage media, and causing a computer (or CPU, MPU, etc.) of the system or apparatus to read out and execute the program.

According to the dental prosthesis fabrication system according to the present disclosure, forming and coloring of a dental prosthesis can be performed based on intraoral information.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A dental prosthesis fabrication system comprising:
an intraoral information obtaining unit that obtains three-dimensional shape information of a tooth and color information of the tooth;
a data generation unit that generates three-dimensional shape data of the tooth and color data of the tooth based on the three-dimensional shape information of the tooth;
a forming unit that forms a dental prosthesis based on the three-dimensional shape data of the tooth; and
a coloring unit that applies color to a surface of the dental prosthesis based on the color data of the tooth.

2. The dental prosthesis fabrication system according to claim 1, wherein the forming unit forms the dental prosthesis by additive manufacturing.

3. The dental prosthesis fabrication system according to claim 1, wherein the forming unit forms the dental prosthesis by repeatedly and sequentially sintering or melting a raw material to solidify through light irradiation.

4. The dental prosthesis fabrication system according to claim 1, wherein the forming unit forms the dental prosthesis by cutting and/or grinding a base material for a dental prosthesis.

5. The dental prosthesis fabrication system according to claim 1, wherein the forming unit forms the dental prosthesis containing a ceramic or a resin.

6. The dental prosthesis fabrication system according to claim 1, wherein the coloring unit applies color to the surface of the dental prosthesis based on brightness data of a tooth on which the dental prosthesis is placed, a tooth in vicinity of a position where the dental prosthesis is placed, or a tooth corresponding to a tooth on which the dental prosthesis is placed.

7. The dental prosthesis fabrication system according to claim 1, wherein the coloring unit applies color based on predicted appearance data of the dental prosthesis obtained from outside a patient's oral cavity based on a position or orientation of placing the dental prosthesis.

8. The dental prosthesis fabrication system according to claim 1, wherein a color having a lower hue b* than a hue b* in chromaticity coordinates defined by L*a*b* color system of CIE 1976 included in the color data of the tooth is applied, as color to be applied by the coloring unit, to a portion of the surface of the dental prosthesis for color matching.

9. The dental prosthesis fabrication system according to claim 8, wherein the portion of the surface of the dental prosthesis is a tip of the dental prosthesis and its nearby area.

10. The dental prosthesis fabrication system according to claim 1, wherein the color to be applied by the coloring unit to the surface of the dental prosthesis is determined based on at least one of placement information of a light source, an intensity of light emitted by the light source, a frequency of the light, or color shade of the light.

11. The dental prosthesis fabrication system according to claim 1, further comprising a display unit, the display unit displaying a plurality of color candidates to be applied to the color surface of the dental prosthesis.

12. The dental prosthesis fabrication system according to claim 11, further comprising an operation unit that receives, from the plurality of color candidates displayed on the display unit, a selection of color to be applied to the surface of the dental prosthesis.

13. The dental prosthesis fabrication system according to claim 11, wherein the plurality of color candidates are displayed along with a matching score with at least one of color data of a tooth on which the dental prosthesis is placed, a tooth in vicinity of a position where the dental prosthesis is placed, or a tooth corresponding to a tooth on which the dental prosthesis is placed.

14. The dental prosthesis fabrication system according to claim 1, wherein the data generation unit does not generate color data exceeding a certain luminance value by comparing the color information of the tooth with the certain luminance value.

15. The dental prosthesis fabrication system according to claim 14, wherein the coloring unit colors the dental prosthesis based on color data not exceeding the certain luminance value.

16. The dental prosthesis fabrication system according to claim 1, wherein the coloring unit has a lookup table that links color data of a tooth to a coloring material for coloring a dental prosthesis, and, by referring to the lookup table, select a coloring material related to color data generated by the data generation unit.

17. A dental prosthesis fabrication method of generating a dental prosthesis, the method comprising:
obtaining three-dimensional shape information of a tooth and color information of the tooth;
generating three-dimensional shape data of the tooth and color data of the tooth based on the three-dimensional shape information of the tooth;
forming a dental prosthesis based on the three-dimensional shape data of the tooth; and
applying color to a surface of the dental prosthesis based on the color data of the tooth.

18. The dental prosthesis fabrication method according to claim 17, further comprising an imaging step of imaging inside a subject's oral cavity.

19. A non-transitory computer-readable medium storing a program that, when executed causes a forming apparatus to execute a step of forming a dental prosthesis using three-dimensional shape data of a tooth generated based on three-dimensional shape information of the tooth, and causing a coloring apparatus to apply color to a surface of the dental prosthesis using color data of the tooth generated based on color information of the tooth present in the tooth.

20. A dental prosthesis coloring method comprising:
a data generation step of generating color data of a tooth based on color information of the tooth obtained using imaging means; and
a coloring step of, using a coloring apparatus, applying color based on the color data of the tooth to a surface of a dental prosthesis formed based on three-dimensional shape data of the tooth generated based on three-dimensional shape information of the tooth obtained using the imaging means.

21. The dental prosthesis coloring method according to claim 20, wherein the dental prosthesis contains a ceramic and/or a resin.

22. The dental prosthesis coloring method according to claim 20, wherein the coloring step applies color, using the coloring apparatus, to the surface of the dental prosthesis using brightness data of a tooth on which the dental prosthesis is placed, a tooth in vicinity of a position where the dental prosthesis is placed, or a tooth corresponding to a tooth on which the dental prosthesis is placed.

23. The dental prosthesis coloring method according to claim 20, wherein the coloring step applies color based on predicted appearance data of the dental prosthesis obtained from outside a patient's oral cavity based on a position or orientation of placing the dental prosthesis.

24. The dental prosthesis coloring method according to claim 20, wherein a color having a lower hue b* than a hue b* in chromaticity coordinates defined by L*a*b* color system of CIE 1976 included in the color data of the tooth is applied, as color to be applied by the coloring apparatus, to a portion of the surface of the dental prosthesis for color matching.

25. The dental prosthesis coloring method according to claim 24, wherein the portion of the surface of the dental prosthesis is a tip of the dental prosthesis and its nearby area.

26. The dental prosthesis coloring method according to claim 20, wherein the color to be applied by the coloring step to the surface of the dental prosthesis is determined based on at least one of placement information of a light source, an intensity of light emitted by the light source, a frequency of the light, or color shade of the light.

27. The dental prosthesis coloring method according to claim 20, further comprising a display step of displaying a plurality of color data candidates to be applied to the surface of the dental prosthesis.

28. The dental prosthesis coloring method according to claim 27, further comprising a selection receiving step of selecting, from the displayed plurality of color candidates, color data to be applied to the surface of the dental prosthesis.

29. The dental prosthesis coloring method according to claim 27, wherein the display step displays the plurality of color candidates along with a matching score with at least one of color data of a tooth on which the dental prosthesis is placed, a tooth in vicinity of a position where the dental prosthesis is placed, or a tooth corresponding to a tooth on which the dental prosthesis is placed.

30. The dental prosthesis coloring method according to claim 20, wherein the data generation step does not generate color data exceeding a certain luminance value by comparing the color information of the tooth with the certain luminance value.

31. The dental prosthesis coloring method according to claim 20, wherein the coloring step comprises a coloring material application step performed by the coloring apparatus.

32. The dental prosthesis coloring method according to claim 31, wherein the coloring step comprises a multi-layer coating step using a plurality of different coloring materials.

33. The dental prosthesis coloring method according to claim 32, wherein the plurality of coloring materials are coloring materials having different refractive indices.

34. The dental prosthesis coloring method according to claim 31, wherein the coloring step has refers to a lookup table that links color data of the tooth to the coloring material, and, by referring to the lookup table, colors the dental prosthesis using a coloring material related to color data generated by the data generation step.

35. The dental prosthesis coloring method according to claim 31, wherein the coloring material contains a light-scattering material.

36. The dental prosthesis coloring method according to claim 35, wherein the light-scattering material is a light-scattering material containing at least one of TiO₂, SiO₂, or ZrO₂.

37. The dental prosthesis coloring method according to claim 31, wherein the coloring material is a coloring material containing at least one of B, Si, or resin.

38. A non-transitory computer-readable medium storing a program that, when executed causes a coloring apparatus to execute a step of applying color to a surface of a dental prosthesis using color data of a tooth generated based on color information of the tooth present in the tooth, the dental prosthesis being formed using three-dimensional shape data of the tooth generated based on three-dimensional shape information of the tooth.

39. A dental prosthesis coloring system that colors a dental prosthesis, the system comprising:
a non-transitory computer-readable medium storing instructions that, when executed, causes the system to:
generate color data of a tooth based on color information of the tooth obtained using imaging means; and
using a coloring apparatus, apply color based on the color data of the tooth to a surface of a dental prosthesis formed based on three-dimensional shape data of the tooth generated based on three-dimensional shape information of the tooth obtained using the imaging means.
